(19) United States
(12) Patent Application Publication
(10) Pub. No.: US 2019/0375390 A1
(43) Pub. Date: Dec. 12, 2019

(54) VEHICULAR BRAKING DEVICE

(71) Applicant: ADVICS CO., LTD., Kariya-shi (JP)

(72) Inventors: Shota HIGASHI, Obu-shi (JP); Yosuke OHMORI, Kariya-shi (JP); Yukio MORI, Kariya-shi (JP)

(73) Assignee: ADVICS CO., LTD., Kariya-shi (JP)

(21) Appl. No.: 16/477,421

(22) PCT Filed: Jan. 25, 2018
(86) PCT No.: PCT/JP2018/002304

§ 371 Date: Jul. 11, 2019

(30) Foreign Application Priority Data
Jan. 25, 2017 (JP) 2017-011558
Jan. 22, 2018 (JP) 2018-008155

(51) Int. Cl. B60T 13/68; B60T 8/17; B60T 13/16

(52) U.S. Cl. CPC B60T 13/686; B60T 13/167; B60T 8/17

(57) ABSTRACT

A vehicular braking device including a pump that discharges a brake fluid to an upstream part connected to two wheel cylinders; a first solenoid valve that adjusts a differential pressure between a master pressure and an upstream pressure that is the pressure of the upstream part; a second solenoid valve that adjusts the pressure of a wheel cylinder; a third solenoid valve that adjusts the pressure an other wheel cylinder; and a control part that controls the pressures of the two wheel cylinders. The control part sets the amount of the brake fluid discharged by the pump on the basis of a required fluid amount to increase the pressure of the low-pressure-side wheel cylinder among the two wheel cylinders up to the same pressure as a target value for the pressure of the high-pressure-side wheel cylinder.

### TECHNICAL FIELD

The present invention relates to a vehicular braking device.

### BACKGROUND ART

Two wheel cylinders of the same brake circuit are connected to a common actuator having solenoid valves and a pump. The pressures (hydraulic pressures) (hereinafter also referred to as “wheel pressures”) of the two wheel cylinders are adjusted by the actuator respectively. The actuator has an upstream part to which the two wheel cylinders are commonly connected. The actuator supplies brake fluid to the upstream part by the pump and controls various types of solenoid valves to adjust each wheel pressure. Here, the solenoid valve provided for each wheel cylinder needs to be opened when simultaneously increasing the pressures of the two wheel cylinders arranged in the same circuit. If there is a difference between the wheel pressures, the brake fluid tends to flow around from the wheel cylinder on the high-pressure-side to the wheel cylinder on the low-pressure-side through the common upstream part. Conventionally, when simultaneously increasing the pressures of the two wheel cylinders of the same circuit having a difference between wheel pressures, the pump is driven to a maximum to supply a large amount of brake fluid to the upstream part and prevent the brake fluid from flowing around.

However, in this configuration, the flowing around of the brake fluid can be prevented, but the driving noise of the pump becomes large, and hence there is a problem in terms of quietness. There is also room for improvement in the power consumption of the pump. On the other hand, for example, in a brake control device described in Japanese Unexamined Patent Application Publication No. 2014-189134, when simultaneously increasing the pressures of the two wheel cylinders of the same circuit having a difference between wheel pressures, the wheel pressure on the high-pressure-side is recovered even if the flowing around has occurred. Thus, the influence of reduction in the wheel pressure on the high-pressure-side is suppressed.

### CITATIONS LIST

### Patent Literature

Patent Literature 1: Japanese Unexamined Patent Application Publication No. 2014-189134

### SUMMARY OF INVENTION

### Technical Problems

However, in the brake control device described above, the flowing around occurs and the wheel pressure on the high-pressure-side is reduced, and hence there is room for improvement in terms of the pressure adjustment accuracy of the wheel pressure. The present invention has been made in view of such circumstances, and it is an object of the present invention to provide a vehicular braking device capable of suppressing noise and reducing power consumption while suppressing the flowing around of the brake fluid.

### Solutions To Problems

A vehicular braking device of the present invention includes: a pump that discharges brake fluid to an upstream part connected to two wheel cylinders; a first solenoid valve provided between a master cylinder and the upstream part to adjust a differential pressure between a master pressure which is a pressure of the master cylinder and an upstream pressure which is a pressure of the upstream part; a second solenoid valve provided between the upstream part and one of the wheel cylinders to adjust a pressure of the one wheel cylinder; a third solenoid valve provided between the upstream part and the other wheel cylinder to adjust the pressure of the other wheel cylinder; and a control part that sets a target value of the pressure of each of the wheel cylinders, and controls the pump, the first solenoid valve, the second solenoid valve, and the third solenoid valve so that the pressure of each wheel cylinder becomes the target value, wherein the control part sets a discharge amount of the pump based on a required fluid amount which is an amount of brake fluid required to increase the pressure of the low-pressure-side wheel cylinder among the two wheel cylinders up to the same pressure as the target value of the pressure of the high-pressure-side wheel cylinder.

### ADVANTAGEOUS EFFECTS OF INVENTION

According to the present invention, since the discharge amount of the pump is set based on the required fluid amount, the pump can be driven with the minimum necessary discharge amount capable of suppressing the flowing around of the brake fluid. Thus, even when the pressures of the two wheel cylinders are simultaneously increased and the two wheel cylinders are communicated through the upstream part, flowing around does not occur, and a decrease in the wheel pressure on the high-pressure-side is suppressed. Furthermore, since the discharge amount of the pump is set based on the required fluid amount, the discharge amount can be made smaller than the discharge amount at the time of maximum drive of the pump, noise can be suppressed, and power consumption can be reduced.

### BRIEF DESCRIPTION OF DRAWINGS

FIG. 1 is a configuration view showing a vehicular braking device according to a first example.

FIG. 2 is a flow chart showing the flow of a flowing around suppression control according to the first example.

FIG. 3 is a time chart describing the flowing around suppression control according to the first example.

FIG. 4 is a configuration view showing a vehicular braking device according to a second example.

FIG. 5 is a time chart describing a first control and a second control according to the second example.

### DESCRIPTION OF EMBODIMENTS

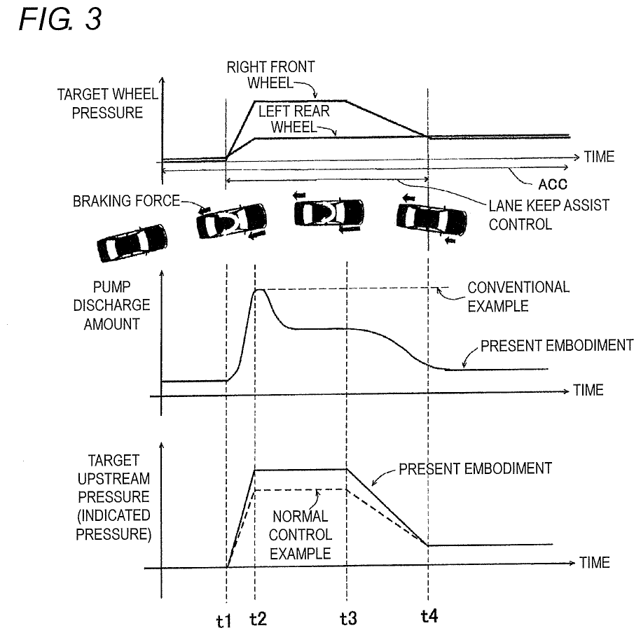

Hereinafter, examples of the present invention will be described based on the drawings. Each figure used for explanation is a conceptual view, and FIG. 3 is an image view for explanation.

### First Example

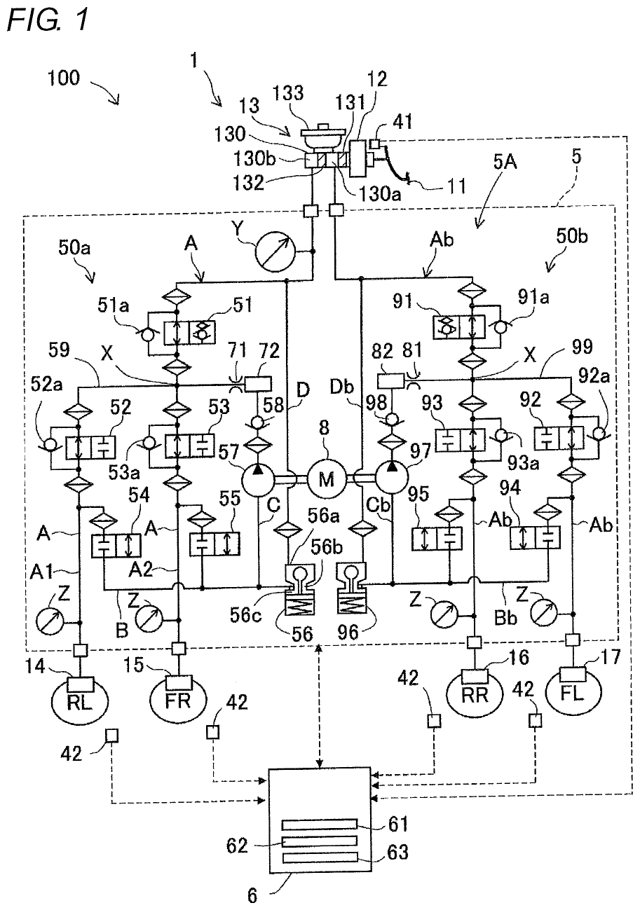

As shown in FIG. 1, a vehicular braking device 100 according to a first example includes a hydraulic pressure generating unit 1, an actuator 5, and a brake ECU (corresponding to a “control part”) 6.

The hydraulic pressure generating unit 1 includes a brake operation member 11, a booster device 12, a cylinder mechanism 13, and wheel cylinders 14, 15, 16, 17. In the first example, the wheel cylinders 14 to 17 (or hydraulic pressure generating unit 1) and the actuator 5 form a braking force applying unit that applies a braking force to a plurality of wheels FR, FL, RR, and RL of the vehicle. The brake operation member 11 of the first example is a brake pedal. The booster device 12 is a known device and is a device that boosts a depressing force applied to the brake operation member 11 by a driver and transmits the same to the cylinder mechanism 13. As the booster device 12, for example, a negative pressure type, a hydraulic pressure type (e.g., a type using a solenoid valve and a high pressure source), or an electric type (e.g., a type using a motor) can be mentioned. The booster device 12 can also be said to be a master piston driving unit that drives the master pistons 131 and 132 in accordance with a brake operation.

The cylinder mechanism 13 includes a master cylinder 130, master pistons 131 and 132, and a reservoir 133. The master cylinder 130 is a bottomed tubular cylinder member. The brake operation member 11 is disposed on the opening side of the master cylinder 130. Hereinafter, for the sake of explanation, the bottom surface side of the master cylinder 130 is referred to as the front side, and the opening side is referred to as the rear side. The master pistons 131 and 132 are slidably disposed in the master cylinder 130. The master piston 132 is disposed on the front side of the master piston 131. The master pistons 131 and 132 partition the inside of the master cylinder 130 into a first master chamber 130a and a second master chamber 130b. The first master chamber 130a is formed by the master pistons 131 and 132 and the master cylinder 130, and the second master chamber 130b is formed by the master piston 132 and the master cylinder 130.

The reservoir 133 is a reservoir tank, and is disposed so as to be able to communicate with the first master chamber 130a and the second master chamber 130b by a flow path. The reservoir 133 and each of the master chambers 130a and 130b are communicated/blocked in accordance the movement of the master pistons 131 and 132. When the master pistons 131 and 132 are in the initial position, the reservoir 133 is in communication with the master chambers 130a and 130b, and when the master pistons 131 and 132 move forward from the initial position by a predetermined distance, the reservoir 133 and the master chambers 130a and 130b are blocked.

The wheel cylinder 14 is disposed on a wheel RL (left rear wheel). The wheel cylinder 15 is disposed on a wheel FR (right front wheel). The wheel cylinder 16 is disposed on a wheel RR (right rear wheel). The wheel cylinder 17 is disposed on a wheel FL (left front wheel). The master cylinder 130 and wheel cylinders 14 to 17 are connected through the actuator 5. The wheel cylinders 14-17 apply a braking force to the wheels RL to FR in accordance with the input hydraulic pressure.

Therefore, when the driver depresses the brake operation member 11, the depressing force is boosted by the booster device 12, and the master pistons 131 and 132 in the master cylinder 130 are pressed. When the master cylinder 130 and the reservoir 133 are blocked by the forward movement of the master pistons 131 and 132 (hereinafter, this state is also referred to as “blocked state”), the same pressure (master pressure) is generated in first master chamber 130a and second master chamber 130b. The hydraulic pressure generating unit 1 generates a master pressure corresponding to the volumes of the first master chamber 130a and the second master chamber 130b in the blocked state in the first master chamber 130a and the second master chamber 130b in which the volumes change according to the movement of the master pistons 131 and 132. The master pressure is reflected on the wheel cylinders 14-17 through the actuator 5. Although not shown, the hydraulic pressure generating unit 1 includes a reaction force spring that generates a reaction force with respect to the operation of the brake operation member 11 until at least the master chambers 130a and 130b are in the blocked state. Furthermore, the hydraulic pressure generating unit 1 may include a stroke simulator that generates a reaction force corresponding to the stroke.

Furthermore, a stroke sensor 41 and a wheel speed sensor 42 are installed in the vehicular braking device 100. The stroke sensor 41 is a sensor that detects the stroke (operation amount) of the brake operation member 11. The wheel speed sensor 42 is a sensor that detects the rotation speed of each of the wheels FR to RL, and is provided for each of the wheels FR to RL. The stroke sensor 41 and the wheel speed sensor 42 transmit the detection result to the brake ECU 6.

The actuator 5 is a device (hydraulic pressure adjusting device) that adjusts the hydraulic pressure (wheel pressure) of the wheel cylinders 14 to 17 in accordance with an instruction from the brake ECU 6. Specifically, as shown in FIG. 1, the actuator 5 includes a hydraulic circuit 5A and a motor 8. The hydraulic circuit 5A includes a first piping system 50a and a second piping system 50b. The first piping system 50a is a system that controls the braking force (pressure of the wheel cylinders 14, 15) to be applied to the wheels RL, FR. The second piping system 50b is a system that controls the braking force (pressure of the wheel cylinders 16, 17) to be applied to the wheels FL, RR. That is, the X piping method is adopted for the piping of the vehicular braking device 100. A front and rear piping method may be adopted.

The first piping system 50a includes a main flow path A, a differential pressure control valve (corresponding to a “first solenoid valve”) 51, a pressure boosting valve (corresponding to a “second solenoid valve”) 52, a pressure boosting valve (“corresponding to a “third solenoid valve”) 53, a pressure reducing flow path B, pressure reducing valves 54 and 55, a pressure adjusting reservoir 56, a reflux flow path C, a pump 57, an auxiliary flow path D, an orifice portion 71 and a damper portion 72. The flow path can be paraphrased as, for example, a pipe line or a hydraulic pressure path.

The main flow path A is a flow path connecting the second master chamber 130b of the master cylinder 130 and the wheel cylinders 14 and 15. The differential pressure control valve 51 is a solenoid valve that is provided in the main flow path A and that controls the main flow path A to a communication state or a differential pressure state. The differential pressure state is a state in which the flow path is restricted by the valve and can also be said to be a throttle state. The differential pressure control valve 51 controls a differential pressure (hereinafter also referred to as a “first differential pressure”) between the pressure on the master cylinder 130 side and the pressure on the wheel cylinders 14 and 15 side according to the current value of the control current based on the instruction of the brake ECU 6. In other words, the differential pressure control valve 51 is configured to control the differential pressure between, with itself as the center, the pressure of a portion on the master cylinder 130 side of the main flow path A and the pressure of a portion on the wheel cylinders 14, 15 side of the main flow path A.

The differential pressure control valve 51 is a normally open type that is in the communication state in the non-energized state. The first differential pressure becomes larger the larger the current value of the control current supplied to the differential pressure control valve 51. When the differential pressure control valve 51 is controlled to a differential pressure state and the pump 57 is driven, the pressure on the wheel cylinders 14 and 15 side becomes higher than the pressure on the master cylinder 130 side according to the current value of the control current. The brake ECU 6 can control the throttle state of the differential pressure control valve 51 by the control current. The main flow path A is branched into two flow paths A1 and A2 at a branch point X on the downstream side of the differential pressure control valve 51 so as to correspond to the wheel cylinders 14 and 15.

The pressure boosting valves 52 and 53 are solenoid valves that open and close according to an instruction from the brake ECU 6 (i.e., based on the current value of the supplied control current), and are normally open type solenoid valves that are in an open state (communication state) in the non-energized state. The pressure boosting valve 52 is disposed in the flow path A1, and the pressure boosting valve 53 is disposed in the flow path A2. The pressure boosting valves 52 and 53 are in the open state in the non-energized state at the time of pressure boosting control thus communicating the wheel cylinders 14 and 15 and the branch point X, and are in the closed state in the energized state at the time of holding control and pressure reducing control thus blocking the wheel cylinders 14, 15 and the branch point X. The pressure boosting valves 52 and 53 may be solenoid valves in which the communication state and the differential pressure state are switched based on an instruction from the brake ECU 6 as with the differential pressure control valve 51.

The pressure reducing flow path B is a flow path that connects between the pressure boosting valve 52 and the wheel cylinder 14 in the flow path A1 and the pressure adjusting reservoir 56, and connects between the pressure boosting valve 53 and the wheel cylinder 15 in the flow path A2 and the pressure adjusting reservoir 56. For example, the pressure boosting valves 52, 53 are controlled to be in the closed state at the time of pressure reducing control, and block master cylinder 130 and the wheel cylinders 14, 15.

The pressure reducing valves 54 and 55 are solenoid valves that open and close in accordance with an instruction from the brake ECU 6, and are normally closed solenoid valves that are in the closed state in the non-energized state. The pressure reducing valve 54 is disposed in a pressure reducing flow path B on the wheel cylinder 14 side. The pressure reducing valve 55 is disposed in the pressure reducing flow path B on the wheel cylinder 15 side. The pressure reducing valves 54 and 55 are energized and opened mainly at the time of pressure reducing control, and communicate the wheel cylinders 14 and 15 and the pressure adjusting reservoir 56 through the pressure reducing flow path B. The pressure adjusting reservoir 56 is a reservoir including a cylinder, a piston, and a biasing member.

A reflux flow path C is a flow path connecting the pressure reducing flow path B (or pressure adjusting reservoir 56) and between (here, branch point X) the differential pressure control valve 51 and the pressure boosting valves 52 and 53 in the main flow path A. The pump 57 is provided in the reflux flow path C so that the discharge port is disposed on the branch point X side and the suction port is disposed on the pressure adjusting reservoir 56 side. The pump 57 is an electric pump driven by the motor 8. The pump 57 causes the brake fluid to flow from the pressure adjusting reservoir 56 to the master cylinder 130 side or the wheel cylinders 14 and 15 side through the reflux flow path C.

The pump 57 is configured to repeat the discharge process of discharging the brake fluid and the suction process of suctioning the brake fluid. That is, the pump 57 is driven by the rotation of the motor 8 and alternately executes the discharge process and the suction process repeatedly. In the discharge process, the brake fluid suctioned from the pressure adjusting reservoir 56 during the suction process is supplied to the branch point X. According to an instruction from the brake ECU 6, the motor 8 is energized through a relay (not shown) and is driven. The pump 57 and the motor 8 together can be referred to as an electric pump.

The orifice portion 71 is a throttle-shaped portion (so-called orifice) provided at a portion between the pump 57 and the branch point X of the reflux flow path C. The damper portion 72 is a damper (damper mechanism) connected to a portion between the pump 57 and the orifice portion 71 of the reflux flow path C. The damper portion 72 absorbs and discharges the brake fluid in accordance with the pulsation of the brake fluid in the reflux flow path C. The orifice portion 71 and the damper portion 72 can be said to be a pulsation reducing mechanism that reduces (attenuates, absorbs) pulsation. A check valve 58 is installed between the damper portion 72 and the pump 57 to permit the flow of brake fluid from the pump 57 to the branch point X and prohibit the flow of brake fluid from the branch point X to the pump 57. The orifice portion 71 may be a check valve that functions as a switching orifice to prohibit the flow of brake fluid from the branch point X to the pump 57 and change the flow path width of the brake fluid from the pump 57 to the branch point X according to the flow rate. In this case, the check valve 58 becomes unnecessary.

An auxiliary flow path D is a flow path connecting a pressure adjusting hole 56a of the pressure adjusting reservoir 56 and the upstream side (or master cylinder 130) of the differential pressure control valve 51 in the main flow path A. The pressure adjusting reservoir 56 is configured so that a valve hole 56b closes with increase in the inflow amount of the brake fluid to the pressure adjusting hole 56a by the increase in stroke. A reservoir chamber 56c is formed on the flow paths B and C side of the valve hole 56b.

When the pump 57 is driven, the brake fluid in the pressure adjusting reservoir 56 or the master cylinder 130 is discharged to a portion (branch point X) between the differential pressure control valve 51 and the pressure boosting valves 52, 53 in the main flow path A through the reflux flow path C. The wheel pressure is boosted (pressurized) according to the control state of the differential pressure control valve 51 and the pressure boosting valves 52 and 53. As described above, in the actuator 5, the pressure boosting control is executed by the drive of the pump 57 and the control of various valves. That is, the actuator 5 is configured to be capable of boosting the wheel pressure. At a portion between the differential pressure control valve 51 and the master cylinder 130 of the main flow path A, a pressure sensor Y for detecting the pressure (master pressure) of the relevant portion is installed. Furthermore, a pressure sensor Z for detecting the wheel pressure is provided with respect to each of the wheel cylinders 14 to 17. The pressure sensors Y, Z transmit the detection results to the brake ECU 6. When estimating the wheel pressure from the control state or the like, the pressure sensor Z may not be installed.

Furthermore, a first check valve 51a is installed in the differential pressure control valve 51. The first check valve 51a is a valve connected in parallel to the differential pressure control valve 51 to allow the flow of brake fluid from the master cylinder 130 to the branch point X and prohibit the flow of brake fluid from the branch point X to the master cylinder 130. A second check valve 52a is installed in the pressure boosting valve 52. The second check valve 52a is a valve connected in parallel to the pressure boosting valve 52 to allow the flow of brake fluid from the wheel cylinder 14 to the branch point X and prohibit the flow of brake fluid from the branch point X to the wheel cylinder 14. A third check valve 53a is installed in the pressure boosting valve 53. The third check valve 53a is a valve connected in parallel to the pressure boosting valve 53 to allow the flow of brake fluid from the wheel cylinder 15 to the branch point X and prohibit the flow of brake fluid from the branch point X to the wheel cylinder 15.

Here, a flow path portion that includes the branch point X and is surrounded by the differential pressure control valve 51, the pressure boosting valves 52, 53, the first check valve 51a, the second check valve 52a, the third check valve 53a, and the check valve 58 is defined as an upstream part 59. That is, the hydraulic circuit 5A includes the upstream part 59 connected to the two wheel cylinders 14, 15. In the description of the check valve 51a, 52a, 53a described above, the “branch point X” can be replaced with the “upstream part 59”.

The second piping system 50b is a system having a configuration similar to that of the first piping system 50a to adjust the pressure of the wheel cylinders 16 and 17. The second piping system 50b includes a main flow path Ab corresponding to the main flow path A, a differential pressure control valve 91 corresponding to the differential pressure control valve 51, pressure boosting valves 92 and 93 corresponding to the pressure boosting valves 52 and 53, a pressure reducing flow path Bb corresponding to the pressure reducing flow path B, pressure reducing valves 94 and 95 corresponding to the pressure reducing valves 54 and 55, a pressure adjusting reservoir 96 corresponding to the pressure adjusting reservoir 56, a reflux flow path Cb corresponding to the reflux flow path C, a pump 97 corresponding to the pump 57, an auxiliary flow path Db corresponding to the auxiliary flow path D, an orifice portion 81 corresponding to the orifice portion 71, a damper portion 82 corresponding to the damper portion 72, a first check valve 91a corresponding to the first check valve 51a, a second check valve 92a corresponding to the second check valve 52a, a third check valve 93a corresponding to the third check valve 53a, and a check valve 98 corresponding to the check valve 58. The second piping system 50b includes an upstream part 99 corresponding to the upstream part 59. As the explanation of the first piping system 50a can be referred to for the detailed configuration of the second piping system 50b, the description thereof will be omitted.

Pressure adjustment of the wheel pressure by the actuator 5 is performed by executing the pressure boosting control for supplying the master pressure to the wheel cylinders 14 to 17 or boosting the wheel pressure by the throttling of the differential pressure control valve 51 and the drive of the pump 57, the holding control for sealing the wheel cylinders 14 to 17, or the pressure reducing control for flowing the fluid in the wheel cylinders 14 to 17 to the pressure adjusting reservoir 56. The pressure boosting control, the holding control, or the pressure reducing control by the actuator 5 can be performed independently for each of the wheel cylinders 14 to 17. For example, in a normal control, the current value of the control current supplied to the differential pressure control valve 51 is set such that the upstream pressure (pressure of the upstream part 59) becomes the same as the wheel pressure on the high-pressure-side of the two wheel cylinders 14, 15. That is, the target value of the upstream pressure in the normal control (hereinafter referred to as “target upstream pressure”) is set based on the difference between the target value of the wheel pressure on the high-pressure-side and the master pressure.

The brake ECU 6 is an electronic control unit including a CPU, a memory, and the like. The brake ECU 6 receives detection results from the stroke sensor 41, the wheel speed sensor 42, the pressure sensors Y, Z, and the like, and controls the operation of the actuator 5 based on the received information. Furthermore, although not shown, the brake ECU 6 receives detection results from various sensors such as an acceleration sensor, a steering angle sensor, an approach sensor (e.g., millimeter wave radar), and a yaw rate sensor. The brake ECU 6 controls the operation of the actuator 5 by supplying a control current to the control target device, and executes the pressure boosting control, the holding control, or the pressure reducing control with respect to each wheel cylinder 14-17. The actuator 5 executes, for example, anti-sideslip control, regenerative coordination control, automatic brake control, lane keep assist control, or anti-skid control (ABS control) by the control of the brake ECU 6. The actuator 5 can execute, for example, constant speed traveling/inter-vehicle distance control (ACC: adaptive cruise control) (hereinafter referred to as “ACC”) by the control of the brake ECU 6.

As described above, the vehicular braking device 100 according to the first example includes the pump 57 (97) that discharges the brake fluid to the upstream part 59 (99) connected to the two wheel cylinders 14, 15 (16, 17); the differential pressure control valve 51 (91) that is provided between the master cylinder 130 and the upstream part 59 (99) to adjust the differential pressure (first differential pressure) between the master pressure which is the pressure of the master cylinder 130 and the upstream pressure which is the pressure of the upstream part 59 (99); the pressure boosting valve 52 (92) that is provided between the upstream part 59 (99) and one of the wheel cylinders 14 to adjust the pressure of one of the wheel cylinders 14; the pressure boosting valve 53 (93) that is provided between the upstream part 59 (99) and the other wheel cylinder 15 to adjust the pressure of the other wheel cylinder 15; and the brake ECU 6 that sets the target value of the pressure of each wheel cylinder 14, 15 (16, 17) and controls the pump 57 (97), the differential pressure control valve 51 (91), the pressure boosting valve 52 (92) and the pressure boosting valve 53 (93) so that the pressure of each wheel cylinder 14, 15 (16, 17) becomes the target value.

### (Flowing Around Suppression Control)

The brake ECU 6 includes, as functions, an operation control part 61 that controls the actuator 5 according to the state of the vehicle, an upstream pressure calculation part 62, and a discharge amount calculation part 63. The operation control part 61 controls the actuator 5 based on information received from various sensors, and executes the pressure boosting control, the pressure reducing control, or the holding control with respect to each of the wheel cylinders 14 to 17. Specifically, the operation control part 61 sets a target value of the pressure of each wheel cylinder (hereinafter referred to as “target wheel pressure”) based on the information received from various sensors. The operation control part 61 controls the various solenoid valves in the actuator 5 and the motor 8 such that each wheel pressure detected by the pressure sensor Z becomes the target wheel pressure. The upstream pressure calculation part 62 and the discharge amount calculation part 63 will be described later.

Here, taking the first piping system 50a as an example, the control of the brake ECU 6 in a state in which there is a possibility that pressure boosting control may be simultaneously executed on the two wheel cylinders 14 and 15 of the same system having a difference in the wheel pressure (simultaneous pressure boosting enabled state) will be described. For the sake of convenience of explanation, the wheel cylinder 14 is assumed as a high-pressure-side. The pressure boosting amount can be set separately for each wheel cylinder 14, 15. In other words, the simultaneous pressure boosting enabled state means a state in which the period of the pressure boosting control has a possibility of overlapping between the two wheel cylinders 14 and 15 (e.g., a state in which ACC and lane keep assist control are simultaneously performed). The brake ECU 6 can execute control to cause the wheels to generate a braking force and to change the traveling direction of the vehicle by the braking force regardless of the driver's operation (brake operation or steering operation).

When pressure is simultaneously boosted in the two wheel cylinders 14 and 15, the pressure boosting valves 52 and 53 are both opened according to the instruction of the brake ECU 6. That is, the wheel cylinder 14 and the wheel cylinder 15 are in the communication state through the upstream part 59. Furthermore, depending on the control, after the pressure is simultaneously boosted in the two wheel cylinders 14 and 15, there is a possibility that the pressure again needs to be simultaneously boosted in the two wheel cylinders 14, 15 until the vehicle reaches the target state (e.g., in the case of lane keep assist control, until the vehicle is stable within the lane), In such a simultaneous pressure boosting enabled state, the brake ECU 6 according to the first example executes a “flowing around suppression control” of suppressing noise (drive noise of the pump 57) and reducing the power consumption while suppressing the flowing around of the brake fluid from the wheel cylinder 14 on the high-pressure-side to the wheel cylinder 15 on the low-pressure-side.

The upstream pressure calculation part 62 calculates a target upstream pressure separately from the target wheel pressures of the wheel cylinders 14 and 15 in order to execute the flowing around suppression control in the simultaneous pressure boosting enabled state. When the target upstream pressure is set, a first differential pressure generated by the differential pressure control valve 51 is determined based on the master pressure (detection value of the pressure sensor Y) and the target upstream pressure. That is, the current value of the control current proportional to the first differential pressure to supply to the differential pressure control valve 51 is determined. The operation control part 61 supplies the current value of the control current set based on the target upstream pressure to the differential pressure control valve 51. At this time, since it is assumed that the driver has not performed the brake operation, the master pressure becomes atmospheric pressure, and the target upstream pressure becomes a value corresponding to the first differential pressure.

The upstream pressure calculation part 62 according to the first example sets by calculation, the current value of the control current proportional to the first differential pressure to supply to the differential pressure control valve 51 to be larger than a current value necessary for adjusting the upstream pressure to the same pressure as the pressure of the side wheel cylinder 14 on the high-pressure-side of the two wheel cylinders 14, 15. Specifically, the upstream pressure calculation part 62 calculates the target upstream pressure (indicated pressure to differential pressure control valve 51) based on the following equation, that is, Qₙₚ=Qₗₕ−Qₗₗ, Q_{SM}=Qₕₕ+Qₙₚ, and P_{SM}=QPₕ (Q_{SM}).

Qₙₚ is the amount of brake fluid to be added to the upstream part 59 (hereinafter referred to as “required additional fluid amount”). Qₗₕ is the amount of brake fluid required to boost the pressure of the wheel cylinder 15 on the low-pressure-side to the target wheel pressure of the wheel cylinder 14 on the high-pressure-side from the predetermined fluid amount (hereinafter referred to as “required fluid amount”). The predetermined fluid amount is a fluid amount set in advance, and is set to 0 here. Qₗₗ is the amount of brake fluid required to boost the pressure of the wheel cylinder 15 on the low-pressure-side to its own target wheel pressure from a predetermined fluid amount. Q_{SM} is the amount of brake fluid required at the upstream part 59 to execute the flowing around suppression control (hereinafter referred to as “required upstream fluid amount”). Qₕₕ is the amount of brake fluid required to boost the pressure of the wheel cylinder 14 on the high-pressure-side to its own target wheel pressure from a predetermined fluid amount. P_{SM} is a target upstream pressure (indicated pressure to the differential pressure control valve 51). QPₕ (Q) is a function that converts the fluid amount to a pressure value.

The target upstream pressure calculated by the upstream pressure calculation part 62 is a value higher than the wheel pressure on the high-pressure-side. The differential pressure between the upstream pressure and the wheel pressure can be generated by the strain of the check valves 51a, 52a, 53a, 58. Furthermore, since the wheel cylinder 14 and the wheel cylinder 15 of the first example have different volumes, the fluid amount (Qₗₕ and Qₕₕ) required to reach the same wheel pressure are also different. As in the first example, the wheel cylinder may differ in volume and characteristics between, for example, the front wheel and the rear wheel.

The discharge amount calculation part 63 calculates the discharge amount per unit tune (requested discharge amount) requested (instructed) to the pump 57 in the flowing around suppression control, that is, the rotation number (requested rotation number) requested on the motor 8. Specifically, the discharge amount calculation part 63 calculates the requested discharge amount based on the following equations, that is, Qₙ=Q_{SM(k)}−Q_{SM(k-1)}, Qₙₚ=Qₗₕ−Qₗₗ, and Qₚₒₘₚ=Qₙ+Qₙₚ. Qₙ is the amount of brake fluid required to boost the pressure in the wheel cylinder 14 on the high-pressure-side (hereinafter referred to as “required pressure boosting fluid amount”). Q_{SM(k)} is a value of the kth (present) Q_{SM}. Q_{SM(k-1)} is a value of the k−1 th (previous) Q_{SM}. Qₚₒₘₚ is a requested discharge amount. The operation control part 61 controls the differential pressure control valve 51 based on the calculated target upstream pressure, and controls the pump 57 (motor 8) based on the calculated requested discharge amount. Thus, the brake ECU 6 sets the discharge amount of the pump 57 based on the required fluid amount Qₗₕ in the flowing around suppression control.

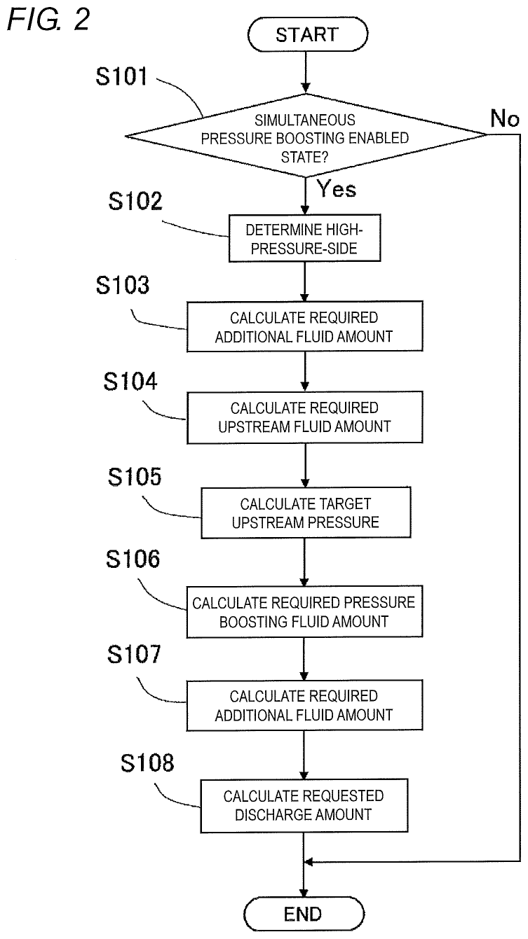

Here, the flow of the flowing around suppression control will be described with reference to FIG. 2. First, when the brake ECU 6 determines that the vehicle is in the simultaneous pressure boosting enabled state (S101: Yes), the upstream pressure calculation part 62 does not perform the target upstream pressure calculation in the normal control, but starts the calculation of the target upstream pressure in the flowing around suppression control (S102). Specifically, first, the upstream pressure calculation part 62 determines whether which of the wheel cylinders 14 and 15 in the same system has a relatively high pressure based on the separately calculated target wheel pressure (or detected value of the pressure sensor Z) (S102). Subsequently, the upstream pressure calculation part 62 calculates the required additional fluid amount Qₙₚ based on the required fluid amount Qₗₕ of the wheel cylinder 15 on the low-pressure-side using the arithmetic equations described above (S103). Then, the upstream pressure calculation part 62 calculates the required upstream fluid amount Q_{SM} based on the arithmetic equations described above (S104), and calculates the target upstream pressure (S105).

Subsequently, the discharge amount calculation part 63 starts calculation of the requested discharge amount (S106). Specifically, the discharge amount calculation part 63 first calculates the required pressure boosting fluid amount Qₙ from the difference between the previous value and the present value of the required upstream fluid amount Q_{SM} (S106). Then, the discharge amount calculation part 63 then calculates or receives from the upstream pressure calculation part 62 the required additional fluid amount Qₙₚ (S107), and calculates the requested discharge amount (S108). The required additional fluid amount Qnp in S107 is a fluid amount for securing the upstream pressure in consideration of the possibility that the brake fluid may be released at a strain portion or the like, and can be said to be a required securing fluid amount. The calculations by the upstream pressure calculation part 62 and the discharge amount calculation part 63 are executed at a constant cycle. The operation control part 61 executes the flowing around suppression control by controlling the differential pressure control valve 51 and the pump 57 (motor 8) based on the target upstream pressure and the requested discharge amount in the simultaneous pressure boosting enabled state.

An example of the flowing around suppression control will be described with reference to FIG. 3. In the example of FIG. 3, a case in which the vehicle executing the ACC further performs the lane keep assist control while traveling and changes the traveling direction is shown. In FIG. 3, the braking force is applied to both wheels FR and RL so that the braking force of the right front wheel FR is larger than the braking force of the left rear wheel RL so that the vehicle turns toward the right in the traveling direction while decelerating the vehicle.

Specifically, when the lane keep assist control is started at t1, the target wheel pressure of the wheel cylinder 15 corresponding to the right front wheel FR is increased, and the target wheel pressure of the wheel cylinder 14 corresponding to the left rear wheel RL is also increased although smaller than the wheel cylinder 15. Accompanying therewith, the discharge amount per unit time of the pump 57 (number of rotations of the motor 8) increases. In this example, the pump 57 and the motor 8 are driven at the maximum driving amount from t1 until t2 at when the target wheel pressure of the wheel cylinder 15 becomes constant. That is, at the time of the first simultaneous pressure boost in this control state, the pump 57 and the motor 8 are controlled to the maximum driving amount with or without calculation in order to increase the braking force at once. Furthermore, the target upstream pressure (indicated pressure to the differential pressure control valve 51) is set to be larger than the target wheel pressure of the wheel cylinder 15 on the high-pressure-side by the calculation of the upstream pressure calculation part 62. Although the target upstream pressure is larger than each target wheel pressure, each wheel pressure can be controlled to a value smaller than the upstream pressure by opening and closing of the pressure boosting valves 52 and 53.

From time t2 until time t4 when the lane keep assist control ends, the pressure boosting control may be simultaneously performed on the two wheel cylinders 14, 15 again. The brake ECU 6 maintains the upstream pressure at a value higher than the wheel pressure of the wheel cylinder 15 on the high-pressure-side by executing the control based on the target upstream pressure calculated by the calculation of the upstream pressure calculation part 62. Furthermore, from t2 to t4, the discharge amount per unit time of the pump 57 is controlled based on the requested discharge amount calculated by the discharge amount calculation part 63, and is maintained at a value smaller than the discharge amount corresponding to the maximum driving amount of the pump 57 and the motor 8. At t3, the target wheel pressure of the wheel cylinder 15 on the high-pressure-side starts to decrease according to the lane keeping condition, and the requested discharge amount and the target upstream pressure also decrease accordingly. When the lane keep assist control ends at t4, the flowing around suppression control also ends, and the normal control returns.

According to the first example, since the requested discharge amount is calculated based on the required fluid amount Qₗₕ in the simultaneous pressure boosting enabled state, the pump 57 and the motor 8 can be driven with the minimum necessary discharge amount capable of suppressing the flowing around. That is, since the minimum fluid amount necessary for the wheel pressure on the low-pressure side to be the same pressure as the wheel pressure on the high-pressure-side is added to the upstream part 59, even when the two wheel cylinders 14 and 15 of the same system are simultaneously pressure boosted and communicated through the upstream part 59, flowing around does not occur, and a decrease in the wheel pressure on the high-pressure-side is suppressed. The discharge amount of the pump 57 at this time is smaller than the discharge amount at the time of maximum drive of the pump 57 and the motor 8 (see dotted line in FIG. 3), the noise is suppressed, and the power consumption is also reduced. For example, when the target wheel pressures of both wheel cylinders 14 and 15 are simultaneously increased from t2 to t4 in FIG. 3, the brake fluid is supplied from the upstream part 59 to the wheel cylinder 14 on the low-pressure-side, and the outflow of the brake fluid from the wheel cylinder 15 on the high-pressure-side to the upstream part 59 is suppressed.

Furthermore, according to the first example, in the flowing around suppression control, the target upstream pressure is set to a value larger than the wheel pressure on the high-pressure-side by calculation based on the required fluid amount Qₗₕ. That is, the current value of the control current supplied to the differential pressure control valve 51 becomes larger than the value corresponding to the target wheel pressure on the high-pressure-side. In a normal control, as shown with a dotted line in FIG. 3, the target upstream pressure is set so that the differential pressure with the master pressure becomes the same pressure as the target wheel pressure on the high-pressure-side. If the target upstream pressure is set to a value higher than that at the time of normal control, as in the first example, the upstream pressure becomes higher than the wheel pressure on the high-pressure-side due to the strain of the check valve 51a and the like. Thus, even when two wheel cylinders 14 and 15 of the same system are simultaneously pressure boosted, the flowing around can be effectively suppressed as the upstream pressure is higher than the wheel pressure. The flowing around can be more accurately suppressed and the decrease in wheel pressure is suppressed by setting the upstream pressure higher than the wheel pressure in addition to the addition of the discharge amount of the pump 57. The change in setting of the target upstream pressure does not affect quietness and is effective also in terms of noise suppression.

### Second Example

A vehicular braking device 100A according to a second example is different from the configuration of the first example mainly in that accumulators 21 and 22 and solenoid valves 31 and 32 are provided. Therefore, different portions will be explained. In the description of the second example, the description of the first example and the drawings can be referred to. The required fluid amount used in the second example is similar to the required fluid amount in the flowing around suppression control of the first example.

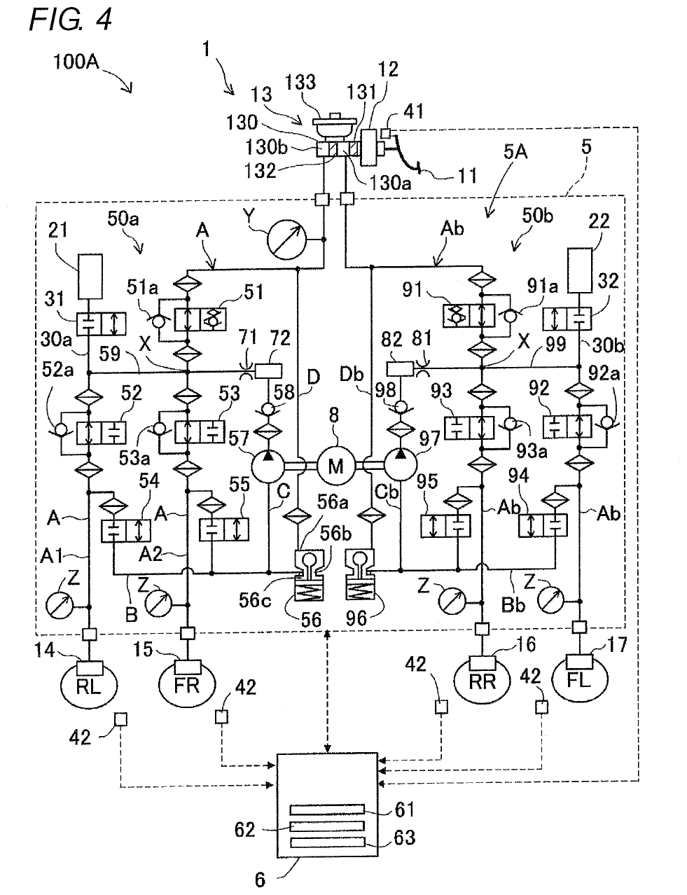

As shown in FIG. 4, in addition to the configuration of the first example, the actuator 5 of the second example includes accumulators (corresponding to “pressure accumulating units”) 21 and 22, and solenoid valves (corresponding to “fourth solenoid valve”) 31 and 32. The configurations of both piping systems 50a and 50b are the same, so the first piping system 50a will be described.

The accumulator 21 is a pressure accumulating device configured to accumulate brake fluid at a hydraulic pressure higher than the wheel pressure. The accumulator 21 can also be said to be a device that accumulates the brake fluid at a pressure corresponding to the upstream pressure (pressure of upstream part 59). The accumulator 21 is connected to the upstream part 59 through a flow path 30a. The solenoid valve 31 is provided between the accumulator 21 and the upstream part 59 (i.e., flow path 30a). The solenoid valve 31 is a normally closed type solenoid valve that is in a closed state in a non-energized state, and is opened and closed based on a command from the brake ECU 6. When the solenoid valve 31 is in the open state, the upstream part 59 and the accumulator 21 communicate with each other and the hydraulic pressure becomes the same to each other.

The brake ECU 6 is configured to execute a first control of opening the solenoid valve 31 while driving the pump 57 according to the required fluid amount in a first state in which the pressure of one wheel cylinder 14 and the pressure of the other wheel cylinder 15 are different and the pressures of both wheel cylinders 14, 15 have reached the target wheel pressure, and execute a second control of opening the solenoid valve 31 (continuously from the first control or newly) when at least the target wheel pressure of the wheel cylinder (14 or 15) on the low-pressure-side is increased from the first state. Furthermore, the brake ECU 6 closes the solenoid valve 31 except during the execution period of the first control and the second control. Thus, the influence of the accumulator 21 can be eliminated in the normal brake control.

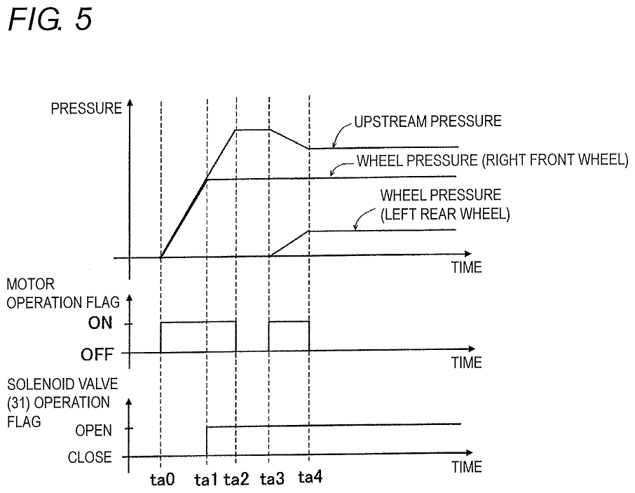

Here, a specific example of the first control and the second control will be described with reference to FIG. 5. As a specific example, a case where a control of increasing the wheel pressure (left rear wheel) on the low-pressure-side in a state where a differential pressure is generated in the wheel pressure (or target wheel pressure) of the wheel cylinders 14 and 15 (right front wheel FR and left rear wheel RL) in the same system has occurred will be described. Since the pump 57 is driven by the drive of the motor 8, ON/OFF of the motor 8 corresponds to ON/OFF of the pump 57. Moreover, the situation of FIG. 5 may occur, for example, when turning on a low _{w} road (road surface with low friction resistance) in automatic driving. That is, for example, a state in which the brake operation by the driver is not performed and the brake control is automatically performed according to the traveling condition can be assumed.

First, at ta0 to ta1, accompanying increase in the target wheel pressure (target braking force) of the right front wheel FR, the differential pressure control valve 51 is controlled by the target upstream pressure higher than the target wheel pressure, the pressure boosting valve 53 is opened, the pressure boosting valve 52 is closed, the motor 8 (pump 57) is driven, and the brake fluid is supplied to the upstream part 59 and the wheel cylinder 15. The upstream pressure and the wheel pressure of the right front wheel FR thus increase. At this time, the brake ECU 6 closes the solenoid valve 31. Furthermore, at this time, the brake ECU 6 calculates the required fluid amount Qₗₕ based on the target wheel pressures of both wheels FR and RL. Then, when the wheel pressure of the right front wheel FR reaches the target wheel pressure, the brake ECU 6 executes the first control. Specifically, the brake ECU 6 maintains the drive of the motor 8 according to the calculated required fluid amount Qₗₕ, closes the pressure boosting valve 53, opens the solenoid valve 31, and communicates the upstream part 59 and the accumulator 21.

Even after ta1, the brake ECU 6 drives the motor 8 based on the required fluid amount Qₗₕ and supplies the brake fluid to the upstream part 59. At this time, the brake fluid supplied to the upstream part 59 is also supplied to the accumulator 21 and is also accumulated in the accumulator 21 together with the upstream part 59. When the brake ECU 6 determines that the required fluid amount Qₗₕ is stored in the upstream part 59 and the accumulator 21 by calculation based on the discharge amount, the brake ECU 6 stops the motor 8 (ta2). In this example, the solenoid valve 31 is opened even after the motor 8 is stopped. That is, the upstream part 59 and the accumulator 21 are maintained in the communication state thus forming one pressure accumulating region (59, 21).

Thereafter, when the target wheel pressure of the left rear wheel RL is boosted from ta3 to ta4, the brake ECU 6 drives the motor 8 and opens the pressure boosting valve 52, and executes the second control to maintain the open state of the solenoid valve 31. At this time, although the outflow of the brake fluid from the wheel cylinder 15 through the pressure boosting valve 53 does not occur since the pressure boosting valve 53 is closed, if the upstream pressure becomes lower than the wheel pressure of the wheel cylinder 15 (right front wheel FR), the brake fluid flow out from the wheel cylinder 15 to the upstream part 59 through the check valve 53a. That is, in a case where the wheel pressure on at least the low-pressure-side is boosted in a state of presence of a differential pressure, flowing around through the check valve 53a may occur by a decrease in the upstream pressure.

However, in the second example, the brake fluid is accumulated in the accumulator 21, and the required fluid amount Qₗₕ is accumulated in the accumulator 21 and the upstream part 59 by the first control (ta1 to ta3). When the pressure boosting valve 52 is opened to boost the wheel pressure of the left rear wheel RL, the brake fluid accumulated in the upstream part 59 and the accumulator 21 is supplied to the wheel cylinder 14 by the second control (ta3 to ta4). The reduction of the wheel pressure on the high-pressure-side due to the flowing around is thus more reliably suppressed. Even if the accumulator 21 is not provided as in the first example, the amount of brake fluid that flows around can be suppressed by accumulating the brake fluid in the upstream part 59 based on the required fluid amount Qₗₕ, but the stored amount of brake fluid can be increased and the flowing around can be more reliably suppressed if the accumulator 21 is provided.

Moreover, according to the second example, since pressure can be accumulated in the accumulator 21, there is no need to rely on strain of a check valve and the like in forming differential pressure between the upstream pressure and wheel pressure (upstream pressure >wheel pressure) and there is no need to increase the upstream pressure more than necessary. The load applied to the motor 8 (pump 57) thus can be reduced.

In addition, when the target wheel pressures of both wheel cylinders 14 and 15 are boosted from the first state, both pressure boosting valves 52 and 53 are opened, which may cause flowing around regardless of the presence or absence of the check valve 53a, but according to the second example, the flowing around can be more reliably suppressed by operations similar to above. Furthermore, according to the second example, for example, even when the differential pressure between both wheel pressures is large (when the required fluid amount Qₗₕ becomes large), the stored amount of the accumulator 21 can be responded and the flowing around can be effectively suppressed regardless of the situation.

After ta4 at which the target wheel pressure of the left rear wheel RL is achieved, the first state (with a differential pressure and the target wheel pressure reached state) is established again, so that the first control is executed and the open state of the solenoid valve 31 is continuously maintained. However, in this example, the motor 8 is stopped as the stored amount of brake fluid has reached the required fluid amount at ta4.

Thus, the brake ECU 6 of the present example does not cooperate the timing of opening/closing the solenoid valve 31 in the first control and the second control with the timing of driving/stopping the motor 8 (pump 57). In the first control and/or the second control, the brake ECU 6 may cooperate the timing of opening/closing the solenoid valve 31 with the timing of driving/stopping the motor 8 (pump 57) (may be executed at the same timing). For example, the brake ECU 6 may end the first control when the motor 8 is stopped, and may close the solenoid valve 31. That is, although the end of the first control is set to the start of the second control (ta3) or at the time of vehicle stop in the example of FIG. 5, it may be set to when the motor 8 is stopped, that is, when the stored amount of brake fluid in the upstream part 59 and the accumulator 21 has reached the required fluid amount Qₗₕ, (ta2). In this case, the solenoid valve 31 is closed at ta2 and opened at ta3.

After ta4, since the stored amount has already reached the required fluid amount, the solenoid valve 31 may be closed immediately. As described above, the timing of closing the solenoid valve 31 in the first control may be set in accordance with the required fluid amount Qₗₕ, similarly to the stopping of the motor 8. In other words, the brake ECU 6 may close the solenoid valve 31 when the amount of brake fluid accumulated in the accumulator 21 and the upstream part 59 has reached the required fluid amount. Similar effects as described above are also exhibited. Furthermore, the timing of opening the solenoid valve 31 in the first control may be after a predetermined time from when the wheel pressure has reached the target wheel pressure (ta1). It can be said that the brake ECU 6 opens the solenoid valve 31 in a first state for a predetermined period (e.g., set to a time longer than or equal to a time required for the stored amount of the pressure accumulating regions 59 and 21 to reach the required fluid amount). The timing to open the solenoid valve 31 in the second control is preferably when the target wheel pressure on the low-pressure-side is boosted.

Moreover, the brake ECU 6 may be configured to determine the presence or absence of execution of the first control and the second control based on the magnitude of the differential pressure of the wheel pressure in the same system. For example, the brake ECU 6 may execute the first control and the second control when the differential pressure between both wheel pressures (target wheel pressures) is greater than or equal to a predetermined value. That is, when the differential pressure is small, this is responded by the storage of the brake fluid in the upstream part 59 without using the accumulator 21, and only when the differential pressure is large, the accumulator 21 may be used. Accordingly, the flowing around can be effectively suppressed while reducing the number of controls on the solenoid valve 31.

Moreover, the second piping system 50b includes an accumulator 22 corresponding to the accumulator 21, and a solenoid valve 32 corresponding to the solenoid valve 31, similar to the first piping system 50a. Furthermore, a flow path 30b of the second piping system 50b corresponds to the flow path 30a. Moreover, as a pressure accumulating unit that accumulates brake fluid, not only accumulator 21 and 22 but another pressure accumulating device may be used.

### Others

The present invention is not limited to the examples described above. For example, in the flowing around suppression control, the target upstream pressure may be set based on the differential pressure between the target wheel pressure on the high-pressure-side and the master pressure as in normal control, and only the discharge amount of the pump 57 may be set based on the required fluid amount Qₗₕ. Even if the upstream pressure and the wheel pressure on the high-pressure-side are the same, flowing around can be suppressed by adding the discharge amount. Furthermore, the configuration for generating the differential pressure between the upstream pressure and the wheel pressure on the high-pressure-side is not limited to a configuration for generating with the strain of the check valve, and may be a configuration for generating with the strain of piping or other members. The present invention is also applicable to automatic driving. Moreover, in the name regarding each instruction by the brake ECU 6, “request” and “target” can be substituted.

1-4. (canceled)

5. A vehicular braking device comprising:
a pump that discharges brake fluid to an upstream part connected to two wheel cylinders;
a first solenoid valve provided between a master cylinder and the upstream part to adjust a differential pressure between a master pressure which is a pressure of the master cylinder and an upstream pressure which is a pressure of the upstream part;
a second solenoid valve provided between the upstream part and one of the wheel cylinders to adjust a pressure of the one wheel cylinder;
a third solenoid valve provided between the upstream part and the other wheel cylinder to adjust the pressure of the other wheel cylinder; and
a control part that sets a target value of the pressure of each of the wheel cylinders, and controls the pump, the first solenoid valve, the second solenoid valve, and the third solenoid valve so that the pressure of each wheel cylinder becomes the target value,
wherein the control part sets a discharge amount of the pump based on a required fluid amount which is an amount of brake fluid required to increase the pressure of the low-pressure-side wheel cylinder among the two wheel cylinders up to the same pressure as the target value of the pressure of the high-pressure-side wheel cylinder.

6. The vehicular braking device according to claim 5, further comprising:
a first check valve connected in parallel with the first solenoid valve to permit the flow of the brake fluid from the master cylinder to the upstream part and prohibit the flow of the brake fluid from the upstream part to the master cylinder;
a second check valve connected in parallel to the second solenoid valve to permit the flow of the brake fluid from the wheel cylinder to the upstream part and prohibit the flow of the brake fluid from the upstream part to the wheel cylinder; and
a third check valve connected in parallel to the third solenoid valve to permit the flow of the brake fluid from the wheel cylinder to the upstream part and prohibit the flow of the brake fluid from the upstream part to the wheel cylinder,
wherein the control part sets a current value provided to the first solenoid valve, which is proportional to the differential pressure, larger than the current value required to adjust the upstream pressure to the same pressure as the pressure of the high-pressure-side wheel cylinder among the two wheel cylinders, based on the required fluid amount.

7. The vehicular braking device according to claim 5, further comprising:
a pressure accumulating unit connected to the upstream part and configured to accumulate the brake fluid at a hydraulic pressure higher than the pressure of the wheel cylinder; and
a fourth solenoid valve provided between the pressure accumulating unit and the upstream part,
wherein in a first state in which the pressure of one wheel cylinder and the pressure of the other wheel cylinder are different and the pressures of both wheel cylinders have reached the target value, the control part executes a first control of opening the fourth solenoid valve while driving the pump according to the required fluid amount, and executes a second control of opening the fourth solenoid valve when the target value of the wheel cylinder at least on the low-pressure-side is increased from the first state.

8. The vehicular braking device according to claim 7, wherein the control part closes the fourth solenoid valve except during an execution period of the first control and the second control.

9. The vehicular braking device according to claim 6, further comprising:
a pressure accumulating unit connected to the upstream part and configured to accumulate the brake fluid at a hydraulic pressure higher than the pressure of the wheel cylinder; and
a fourth solenoid valve provided between the pressure accumulating unit and the upstream part,
wherein in a first state in which the pressure of one wheel cylinder and the pressure of the other wheel cylinder are different and the pressures of both wheel cylinders have reached the target value, the control part executes a first control of opening the fourth solenoid valve while driving the pump according to the required fluid amount, and executes a second control of opening the fourth solenoid valve when the target value of the wheel cylinder at least on the low-pressure-side is increased from the first state.

10. The vehicular braking device according to claim 9, wherein the control part closes the fourth solenoid valve except during an execution period of the first control and the second control.
